(19) United States
(12) Patent Application Publication
(10) Pub. No.: US 2007/0124565 A1
(43) Pub. Date: May 31, 2007

(54) RECONFIGURABLE PROCESSING ARRAY HAVING HIERARCHICAL COMMUNICATION NETWORK

(75) Inventors: Anthony Mark Jones, Beaverton, OR (US); Paul M. Wasson, Beaverton, OR (US); Michael R. Butts, Beaverton, OR (US)

Correspondence Address: AMBRIC, INC.;C/O MARGER JOHNSON & MCCOLLOM PC, 210 SW MORRISON STREET, SUITE 400, PORTLAND, OR, 97204, US

(73) Assignee: AMBRIC, INC., Beaverton, OR (US)

(21) Appl. No.: 11/557,478

(22) Filed: Nov. 7, 2006

Related U.S. Application Data
(63) Continuation-in-part of application No. 10/871,347, filed on Jun. 18, 2004, now Pat. No. 7,206,870.
(63) Continuation-in-part of application No. 11/458,061, filed on Jul. 17, 2006.
Application No. 11/458,061 is a continuation-in-part of application No. 11/340,957, filed on Jan. 27, 2006.
(60) Provisional application No. 60/734,623, filed on Nov. 7, 2005.
(60) Provisional application No. 60/479,759, filed on Jun. 18, 2003.

(51) Int. Cl. G06F 9/40; G06F 15/00

(52) U.S. Cl. 712/201

(57) ABSTRACT

A processor includes multiple compute units and memory units arranged in groups of abutted tiles. Multiple tiles are arranged together along with input/output interfaces to form a processor system that can be configured to perform many different operations. A hierarchical communication network efficiently connects components within the tiles and between multiple tiles.

This application claims benefit of U.S. Provisional application 60/734,623, filed Nov. 7, 2005, entitled Tesselated Multi-Element Processor and Hierarchical Communication Network, and is a Continuation-in-Part of U.S. application Ser. No. 10/871,347, filed Jun. 18, 2004, entitled Data Interface for Hardware Objects, currently pending, which in turn claims benefit of U.S provisional application 60/479,759, filed Jun. 18, 2003, entitled Integrated Circuit Development System. Further, this application is a continuation-in-part of U.S. application Ser. No. 11/458,061, filed Jul. 17, 2006, entitled System of Virtual Data Channels Across Clock Boundaries in an Integrated Circuit, and U.S. application Ser. No. 11/340,957, filed Jan. 27, 2006, entitled System of Virtual Data Channels in an Integrated Circuit. All of these applications are herein incorporated by reference in their entirety.

### TECHNICAL FIELD

This disclosure relates to an integrated circuit, and, more particularly, to a microprocessor network formed from a number of systematically arranged compute elements and to a communication network that passes data within and between the compute elements.

### BACKGROUND

Microprocessors are well known. A microprocessor is a generic term for an integrated circuit that can perform operations for a wide range of applications. They are the central computing units for computers and many other devices. Microprocessors typically contain memory (to store data and instructions), an instruction decoder, an execution unit, a number of data registers, and communication interfaces for one or more data and/or instruction buses. Sometimes Arithmetic Logic Units (ALUs) are also included within a microprocessor and sometimes they are separate circuits.

For many years, most processors have included a single execution unit surrounded by supporting circuitry, such as the decoders and registers listed above. Recently, however, many processor designers are including multiple execution cores within a single processor. Intel's latest microprocessor offerings include 2 execution cores, with plans to distribute additional “multi-core” products. The “Cell Processor” from IBM also includes several processors. Both of these offerings include complex communication systems and large data buses, which demand increasingly complex communication control overhead for the additional benefit of having multiple execution cores. Indeed, as the number of execution cores in these multi-core systems increases, the communication control and overhead becomes even more complex; this in turn makes programming such systems increasingly difficult.

Another class of microprocessors uses dozens or hundreds or small processors connected by an interconnection network. Example interconnection networks are discussed in U.S. Pat. No. 6,769,056, including exotic nearest neighbor networks such as torus, mesh, folded and hypercube networks. As described in the '056 patent, the of interconnection wires in a typical communication network for a massively parallel multiprocessor is very large, and consumes valuable layout ‘real estate’ that could otherwise be used to maximize the computing power of the processor.

Embodiments of the invention address these and other limitations in the prior art.

### BRIEF DESCRIPTION OF THE DRAWINGS

FIG. 1 is a block diagram of a tessellated multi-element processor according to embodiments of the invention.

FIG. 2 is a block diagram of example components that can make up individual tiles of the system illustrated in FIG. 1 according to embodiments of the invention.

FIG. 3 is a block diagram of an example protocol register that can be used throughout the system of FIG. 1 in its communication channels.

FIG. 3 is a block diagram illustrating components of an example computing unit contained within the tile of FIG. 2, according to embodiments of the invention.

FIG. 4 is a block diagram illustrating a communication network within a single compute unit illustrated in FIG. 2.

FIG. 5 is a block diagram illustrating local communication connections between compute elements according to embodiments of the invention.

FIG. 6 is a block diagram illustrating intermediate communication connections between compute elements according to embodiments of the invention.

FIGS. 7 and 8 are example block diagrams illustrating intermediate and distance communication switches coupled through a communication network according to embodiments of the invention.

FIG. 9 is a block diagram illustrating a hierarchical communication network for an array of computing resources according to embodiments of the invention.

FIG. 10 is a block diagram of multiple communication systems within a portion of an integrated circuit according to embodiments of the invention.

FIG. 11 is a block diagram of an example portion of an example switch of a communication network illustrated in FIG. 6 according to embodiments of the invention.

FIG. 12 is a block diagram of an example of programmable interface between a portion of a network switch of FIG. 11 and input ports of an electronic component in the system 10 of FIG. 1

### DETAILED DESCRIPTION

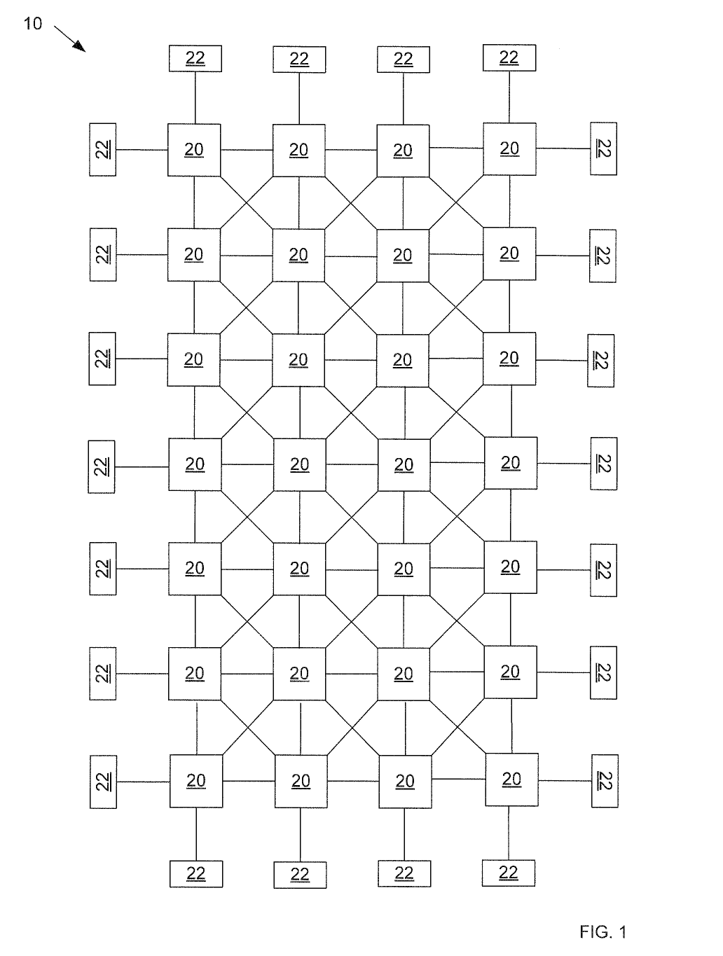

FIG. 1 illustrates a tiled or tessellated multi-element processor system 10 according to embodiments of the invention. Central to the processor system 10 are multiple tiles 20 that are arranged and placed according to available area of the system 10 and size of the tiles 20. Additionally, Input/Output (I/O) blocks 22 are illustrated around the periphery of the system 10. The I/O blocks are coupled to some of the outer tiles 20 and provide communication paths between the tiles 20 and elements outside of the system 10. Although the I/O blocks 22 are illustrated as being around the periphery of the system 10, in practice the blocks 22 may be placed anywhere within the system.

The number and placement of tiles 20 may be dictated by the size and shape of the tiles, as well as external factors, such as cost. Although only twenty eight tiles 20 are illustrated in FIG. 1, the actual number of tiles placed within the system 10 may depend on multiple factors. For instance, as process technologies scale smaller, more tiles 20 may fit within the system 10. In some instances, the number of tiles 20 may be purposely be kept small to lower the overall cost of the system 10, or to scale the computing power of the system 10 to desired applications. In addition, although the tiles 20 are illustrated as being in a 4×7 arrangement, the tiles may be laid in any geometric arrangement. Square and rectangular arrangements could be common, to match common semiconductor geometries. Additionally, if the multi-processor system I/O is only a portion of a larger circuit, the system 10 may be shaped to fit around other portions of such a larger circuit. For instance, the tiles 20 may encircle a conventional microprocessor or group of processors. Further, although only one type of tile 20 is illustrated in FIG. 1, different types and numbers of tiles may be integrated within a single processor system 10.

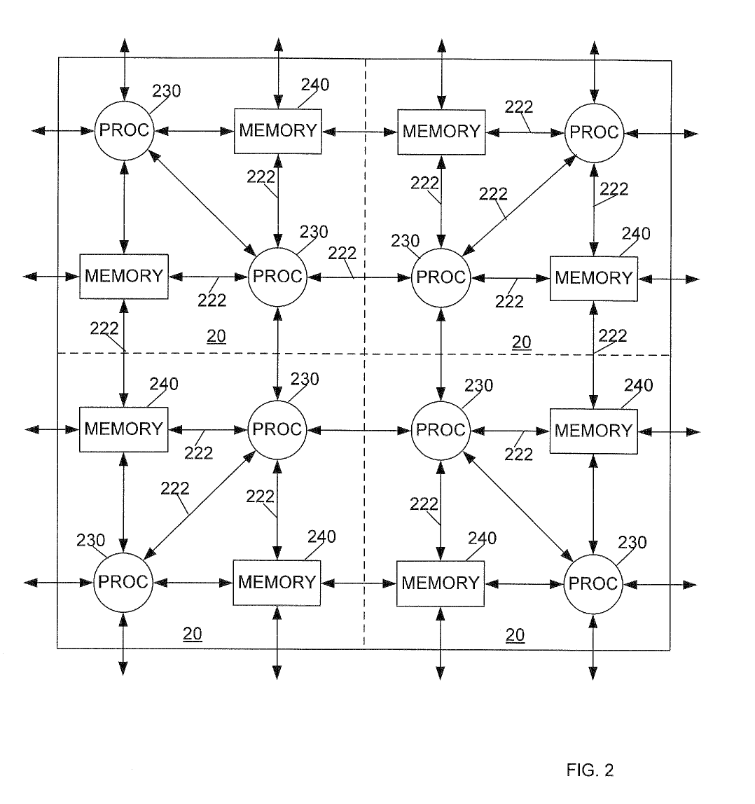

FIG. 2 illustrates components of example tiles 20 of the system 10 illustrated in FIG. 1. In this figure, four tiles 20 are illustrated. The components illustrated in FIG. 2 could alternately be thought of as one, two, four, or eight tiles 20, each having a different number of processor-memory pairs. For the remainder of this document, however, a tile 20 will be referred to as illustrated by the delineation in FIG. 2, having two processor-memory pairs. In the system described, there are two types of tiles illustrated, one with processors in the upper-left and lower-right corners, and another with processors in the upper-right and lower-left corners. Other embodiments can include different geometries, as well as different number of components. Additionally, as described below, there is no requirement that the number of processors equal the number of memory units in each tile 20.

In FIG. 2, an example tile 20 includes processor or “compute” units 230 and “memory” units 240. The compute units 230 include mostly computing resources, while the memory units 240 include mostly memory resources. There may be, however, some memory components within the compute unit 230 and some computing components within the memory unit 240, as described below. In this configuration, each compute unit 230 is primarily associated with one memory unit 240, although it is possible for any compute unit to communicate with any memory unit within the system 10 (FIG. 1).

Data communication lines 222 connect units 230, 240 to each other as well as to units in other tiles 20. The data communication lines can be serial or parallel lines. They may include virtual communication channels such as those described in U.S. patent application Ser. No. 11/458,061, referenced above. The structure and architecture of the data communication lines 222 give the system 10 tremendous flexibility in how the processors 230 and memory 240 of the tiles 20 communicate with one another.

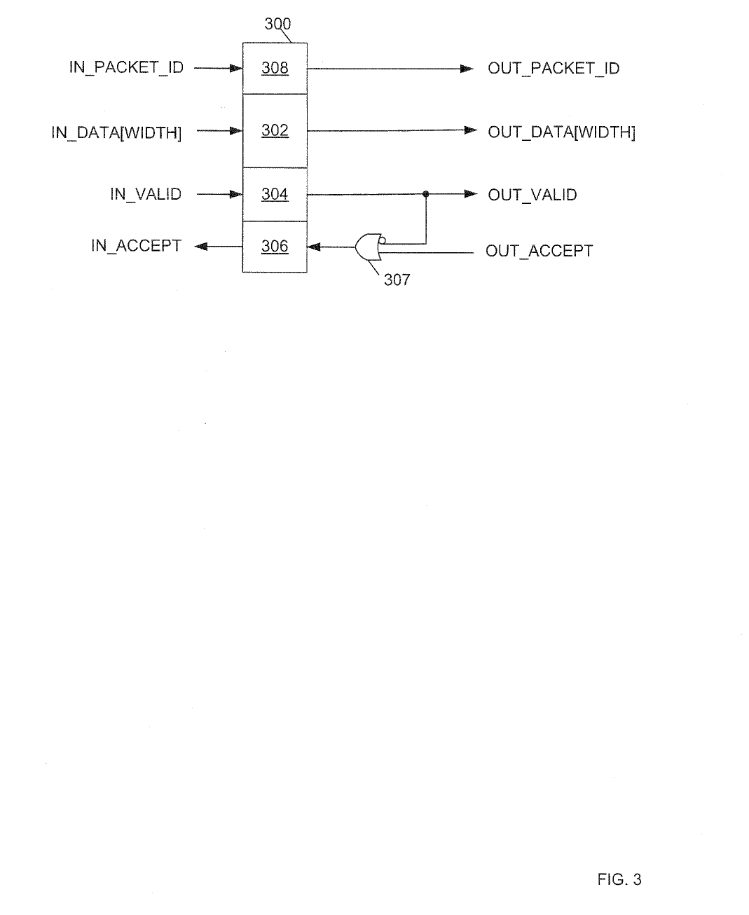

FIG. 3 is a block diagram illustrating a protocol register 300, the function and operation of which is described in the above-referenced U.S. patent application Ser. No. 10/871,329. The register 300 includes at least one set of storage elements between an input interface and an output interface. Multiple registers 300 can be inserted anywhere between a data source and its destination.

The input interface uses an accept/valid data pair to control dataflow. If both valid and accept are both asserted, the register 300 sends data stored in sections 302 and 308 to a next register in the datapath, and new data is stored in 302, 308. Further, if out_valid is de-asserted, the register 300 updates with new data while the invalid data is overwritten. This push-pull protocol register 300 is self synchronizing in that it only sends data to a subsequent register (not shown) if the data is valid and the subsequent register is ready to accept it. Likewise, if the protocol register 300 is not ready to accept data, it de-asserts the in_accept signal, which informs a preceding protocol register (not shown) that the register 300 is not accepting.

In some embodiments, the packet_id value stored in the section 308 is formed of multiple bits. In other embodiments the packet_id is a single bit and operates to indicate that the data stored in the section 302 is in a particular packet, group or word of data. In a particular embodiment, a LOW value of the packet_id indicates that it is the last word in a message packet. All other words would have a HIGH value for packet_id. Using this indication, the first word in a message packet can be determined by detecting a HIGH packet_id value that immediately follows a LOW value for the word that precedes the current word. Alternatively stated, the first HIGH value for the packet_id that follows a LOW value for a preceding packet_id indicates the first word in a message packet. Only the first and last word can be determined if using a single bit packet_id.

The width of the data storage section 302 can vary based on implementation requirements. Typical widths would include 4, 8, 16, and 32 bits.

With reference to FIG. 2, the data communication lines 222 would include a register 300 at least at each end of communication lines. Additional registers 300 could be inserted anywhere along the communication lines 222 (or in other communication paths in the system 10) without changing the logical operation of the communication.

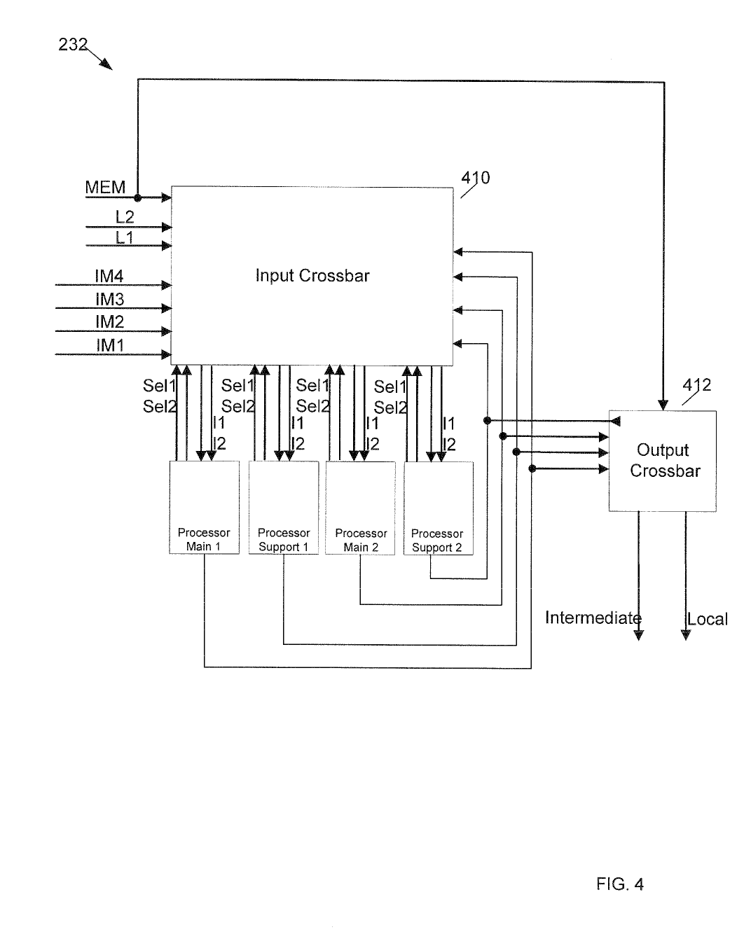

FIG. 4 illustrates an example implementation processor 232 including a communication network. Central to the communication network of the processor 232 is an input crossbar, 410, the output of which is coupled to four individual processors. In this example, each compute unit 230 includes two Main processors and two Support processors. From a communication standpoint, each of the Main and Support processors are identical, although in practicality, they may have different capabilities.

Each of the processors has two inputs, 11 and 12, and two selection lines Sell, and Sel2. In operation, control signals on the output lines Sell, Sel2 programmatically control the input crossbar 410 to select which of the inputs to the input crossbar 410 will be selected as inputs on lines l1 and l2, for each of the four processors, separately. In some embodiments of the invention, the inputs 11 and 12 of each processor can select any of the input lines to the input crossbar 410. In other embodiments, only subsets of all of the inputs to the input crossbar 410 are capable of being selected. This latter embodiment could be implemented to minimize cost, power consumption or area of the input crossbar 410.

Inputs to the input crossbar 410 include a communication channel from the associated memory unit, MEM, two local channel communication lines, L1, L2, and four intermediate communication lines IMI-IM4. These inputs are discussed in detail below.

Protocol registers (not shown) may be placed anywhere along the communication paths. For instance, protocol registers 300 may be placed at the junction of the inputs L1,L2,IM1-IM4, and MEM with the input crossbar 410, as well as on the intput and output of the individual Main and Support processors. Additional registers may be placed at the inputs and/or outputs of the output crossbar 412.

The input crossbar 410 may be dynamically controlled, such as described above, or may be statically configured, such as by writing data values to configuration registers during a setup operation, for instance.

An output crossbar 412 can connect any of the outputs of the Main or Support processors, or the communication channel from the memory unit, MEM, as either an intermediate or a local output of the processor 230. In the illustrated embodiment the output crossbar 412 is statically configured during the setup stage, although dynamic (or programmatic) configuration would be possible by adding appropriate output control from the Main and Support processors.

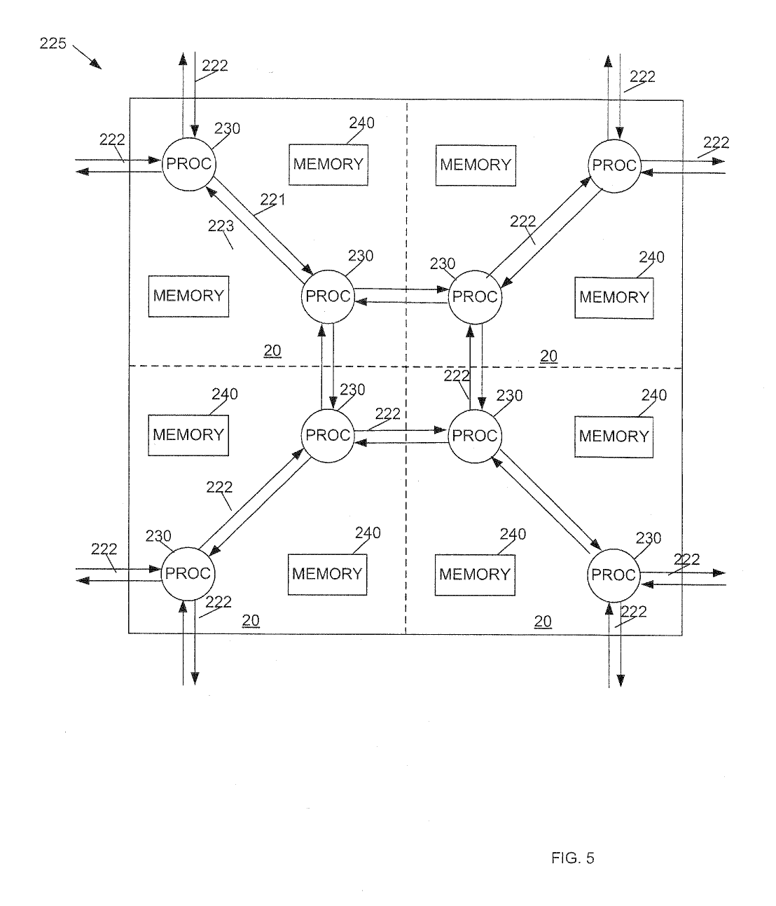

FIG. 5 illustrates a local communication system 225 between compute units 230 within an example tile 20 of the system 10 according to embodiments of the invention. The compute and memory units 230, 240 of FIG. 5 are situated as they were in FIG. 2, although only the communication system 225 between the compute units 230 is illustrated in FIG. 5. Additionally, in FIG. 5, data communication lines 222 are illustrated as a pair of individual unidirectional communication paths 221, 223, running in opposite directions.

In this example, each compute unit 230 includes a horizontal network connection, a vertical network connection, and a diagonal network connection. The network that connects one compute unit 230 to another is referred to as the local communication system 225, regardless of its orientation and which compute units 230 it couples to. Further, the local communication system 225 may be a serial or a parallel network, although certain time efficiencies are gained from it being implemented in parallel. Because of its character in connecting only adjacent compute units 230, the local communication system 225 may be referred to as the ‘local’ network. In this embodiment, as shown, the communication system 225 does not connect to the memory modules 240, but could be implemented to do so, if desired. Instead, an alternate implementation is to have the memory modules 240 communicate on a separate memory communication network (not shown).

The local communication system 225 can take output from one of the Main or Supplemental processors within a compute unit 230 and transmit it directly to another processor in another compute unit to which it is connected. As described with reference to FIGS. 3 and 4, the local communication system 225 may include one or more sets of storage registers (not shown), such as the protocol register 300 of FIG. 3, to store the data during the communication. In some embodiments, registers on the same local communication system 225 may cross clock boundaries and therefore may include clock-crossing logic and lockup latches to ensure proper data transmission between the compute units 230.

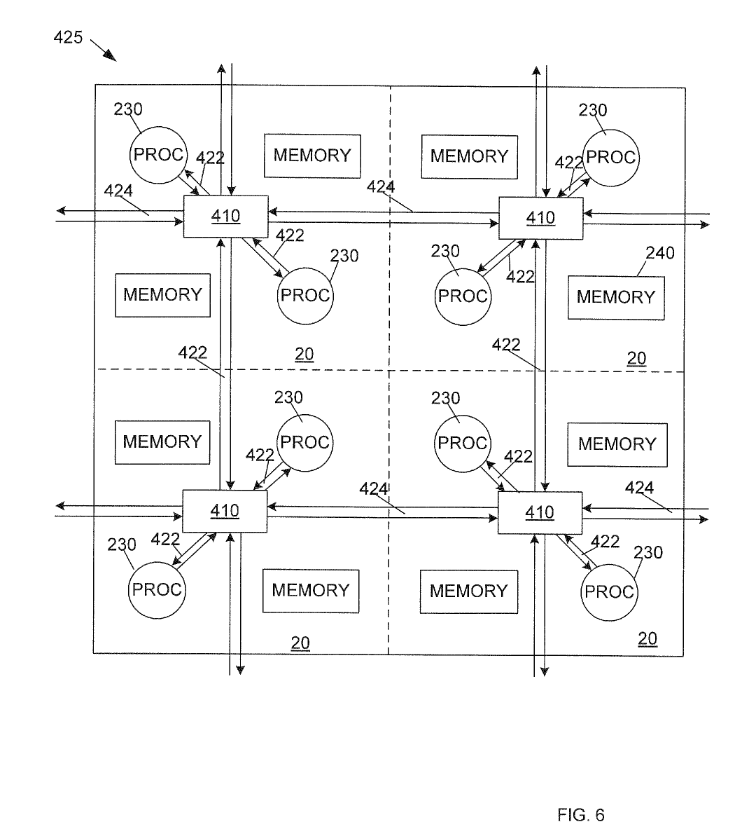

FIG. 6 illustrates another communication system 425 within the system 10, which can be thought of as another level of communication within an integrated circuit. The communication system 425 is an ‘intermediate’ distance network and includes switches 410, communication lines 422 to processors 230, and communication lines 424 between switches themselves. As above, the communication lines 422, 424 can be made from a pair of unidirectional communication paths running in opposite directions. In this embodiment, as shown, the communication system 425 does not connect to the memory modules 240, but could be implemented in such a way, if desired.

In FIG. 6, one switch 410 is included per tile 20, and is connected to other switches in the same or neighboring tiles in the north, south, east, and west directions. The switch 410 may instead couple to an Input/Output block (not shown), Thus, in this example, the distance between the switches 410 is equivalent to the distance across a tile 20, although other distances and connection topologies can be implemented without deviating from the scope of the invention.

In operation, any processor 230 can be coupled to and can communicate with any other processor 230 on any of the tiles 20 by routing through the correct series of switches 410 and communication lines 422, 424, as well as through the communication network 425 of FIG. 5. For instance, to send communication from the processor 230 in the lower left hand corner of FIG. 6 to the processor 230 in the upper right corner of FIG. 6, three switches 410 (the lower left, upper right, and one of the possible two switches in between) could be configured in a circuit switched manner to connect the processors 230 together. The same communication channels could operate in a packet switching network as well, using addresses for the processors 230 and including routing tables in the switches 410, for example.

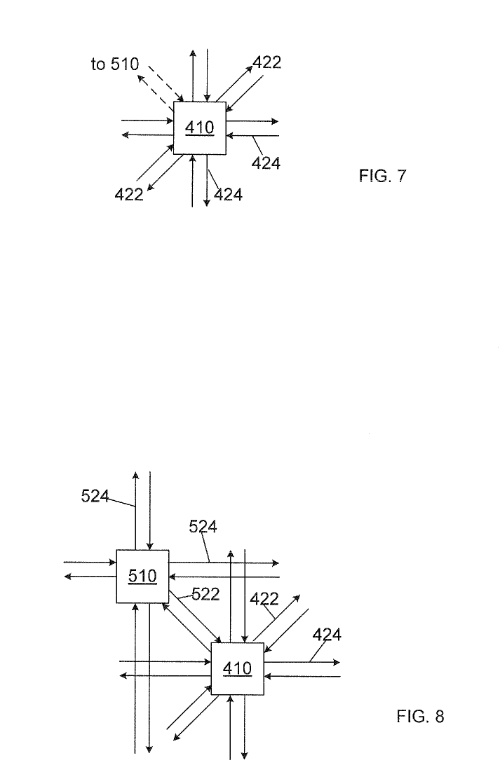

Also as illustrated in FIGS. 7, 8, 9, and 10, some switches 410 may be connected to yet a further communication system 525, which may be referred to as a ‘distance’ network. In the example system illustrated in these figures, the communication system 525 includes switches 510 that are spaced apart twice as far in each direction as the communication system 425, although this is given only as an example and other distances and topologies are possible. The switches 510 in the communication system 525 connect to other switches 510 in the north, south, east, and west directions through communication lines 524, and connect to a switch 410 (in the intermediate communication system 425) through a local connection 522 (FIG. 8).

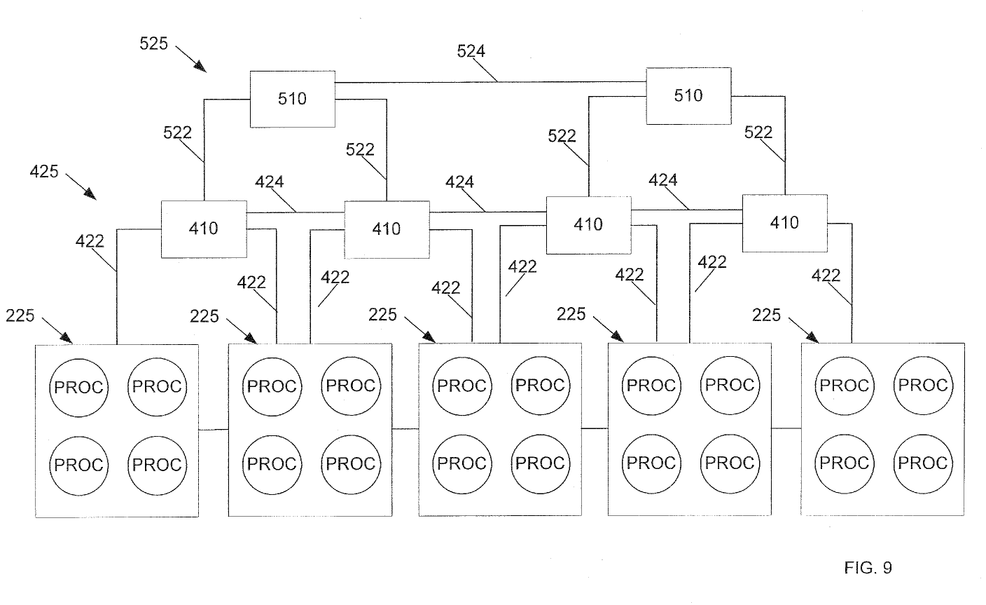

FIG. 9 is a block diagram of hierarchical network in a single direction, for ease of explanation. At the lowest level illustrated in FIG. 9, groups of processors communicate within each group and between nearest groups of processors by the communication system 225, as was described with reference to FIG. 5. The local communication system 225 is coupled to the communication system 425 (FIG. 6), which includes the intermediate switches 410. Each of the intermediate switches 410 couples between groups of local communication systems 225, allowing data transfer from a compute unit 230 (FIG. 2) to another compute unit 230 to which it is not directly connected through the local communication system 225.

Further, the intermediate communication system 425 is coupled to the communication system 525 (FIG. 8), which includes the switches 510. In this example embodiment, each of the switches 510 couples between groups of intermediate communication systems 425.

Having such a hierarchical data communication system, including local, intermediate, and distance networks, allows for each element within the system 10 (FIG. 1) to communicate to any other element with fewer ‘hops’ between elements when compared to a flat network where only nearest neighbors are connected.

The communication networks 225, 425, and 525 are illustrated in only 1 dimension in FIG. 9, for ease of explanation. Typically the communication networks are implemented in two-dimensional arrays, connecting elements throughout the system 10.

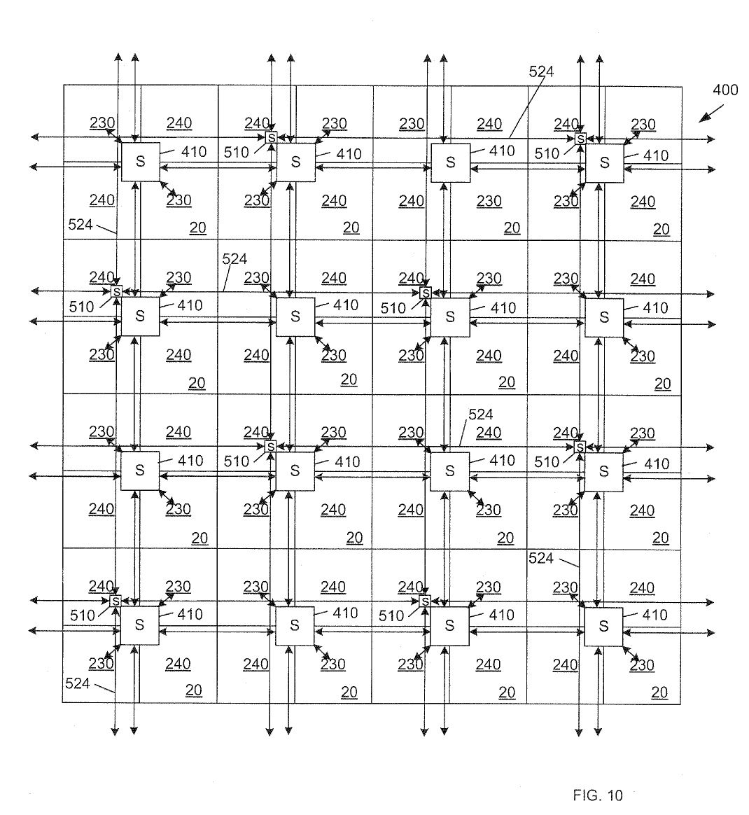

FIG. 10 is a block diagram of a two-dimensional array illustrating sixteen tiles 20 assembled in a 4×4 pattern as a portion of an integrated circuit 400. Within the integrated circuit 400 of FIG. 10 are the three communication systems, local 225, intermediate 425, and distance 525 explained previously.

The switch 410 in every other tile 20 (in each direction) is coupled to a switch 510 in the long-distance network 525. In the embodiment illustrated in FIG. 10, there are two long distance networks 525, which do not intersect one another. Of course, how many of each type of communication networks 225, 425, and 525 is an implementation design choice. As described below, switches 410 and 510 can be of similar or identical construction,

In operation, processors 230 communicate to each other over any of the networks described above. For instance, if the processors 230 arc directly connected by a local communication network 225 (FIG. 5), then the most direct connection is over such a network. If instead the processors 230 are located some distance away from each other, or are otherwise not directly connected by a local communication network 225, then communicating through the intermediate communication network 425 (FIG. 6) may be the most efficient. In such a communication network 425, switches 410 are programmed to connect output from the sending processor 230 to an input of a receiving processor 310, an example of which is described below. Data may travel over communication lines 422 and 424 in such a network, and could be switched back down into the local communication network 225. Finally, in those situations where a receiving processor 230 is a relatively far distance from the sending processor 230, the distance network 525 of FIGS. 8 and 10 may be used. In such a distance network 525, data from the sending processor 230 would first move from its local network 225 through an intermediate switch 410 and further to one of the distance switches 510. Data is routed through the distance network 525 to the switch 510 closest to the destination processor 230. From the distance switch 510, the data is transferred through another intermediate switch 410 on the intermediate network 425 directly to the destination processor 230. Any or all of the communication lines between these components may include conventional, programmable, and or virtual data channels as best fits the purpose. Further, the communication lines within the components may have protocol registers 300 of figure 3, inserted anywhere between them without affecting the data routing in any way.

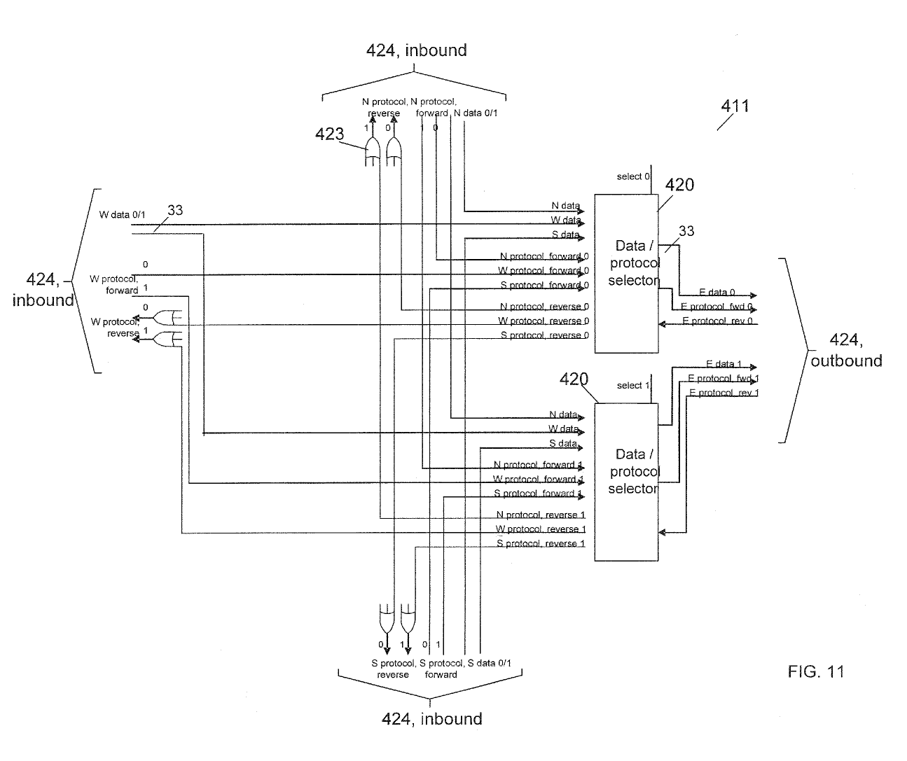

FIG. 11 is a block diagram illustrating a portion of an example switch structure 411. For clarity, only a portion of a full switch 410 of FIG. 6 is shown, as will be described. Generally, various lines and apparatus in the East direction illustrate components that make up output circuitry, only, including communication lines 424 in the outbound direction, while the North, South, and West directions illustrate inbound communication lines 424, only. Of course, even in the “outbound” direction, which describes the direction of the main data travel, there are input lines, as illustrated, which carry reverse protocol information for the protocol registers 300 of FIG. 3. Similarly, in the “inbound” direction, reverse protocol information is an output. To create an entire switch 410 (FIG. 6), the components illustrated in FIG. 11 are duplicated three times, for the North, South, and West directions, as well as extra directions for connecting to the local communication network 225. In this example, each direction includes a pair of data and protocol lines, in each direction.

A pair of data/protocol selectors 420 can be structured to select one of three possible inputs, North, South, or West as an output. Each selector 420 operates on a single channel, either channel 0 or channel 1 from the inbound communication lines 424. Each selector 420 includes a selector input to control which input, channel 0 or channel 1, is coupled to its outputs. The selector 420 input can be static or dynamic. Each selector 420 operates independently, i.e., the selector 420 for channel 0 may select a particular direction, such as North, while the selector 420 for channel 1 may select another direction, such as West. In other embodiments, the selectors 420 could be configured to make selections from any of the channels, such as a single selector 420 sending outputs from both West channel 1 and West channel 0 as its output, but such a set of selectors 420 would be larger and use more component resources than the one described above.

Protocol lines of the communication lines 424, in both the forward and reverse directions are also routed to the appropriate selector 420. In other embodiments, such as a packet switched network, a separate hardware device or process (not shown) could inspect the forward protocol lines of the inbound lines 424 and route the data portion of the inbound lines 424 based on the inspection. The reverse protocol information between the selectors 420 and the inbound communication lines 424 are grouped through a logic gate, such as an OR gate 423 within the switch 411. Other inputs to the OR gate 423 would include the reverse protocol information from the selectors 420 in the West and South directions. Recall that, relative to an input communication line 424, the reverse protocol information travels out of the switch 411, and is coupled to the component that is sending input to the switch 411.

The version of the switch portion 411 illustrated in FIG. 11 has only communication lines 424 to it, which connect to other switches 410, and does not include communication lines 422, which connect to the processors 230. A version of the switch 410 that includes communication lines 422 connected to it is described below.

Switches 510 of the distance network 525 may be implemented either as identical to the switches 410, or may be more simple, with a single data channel in each direction.

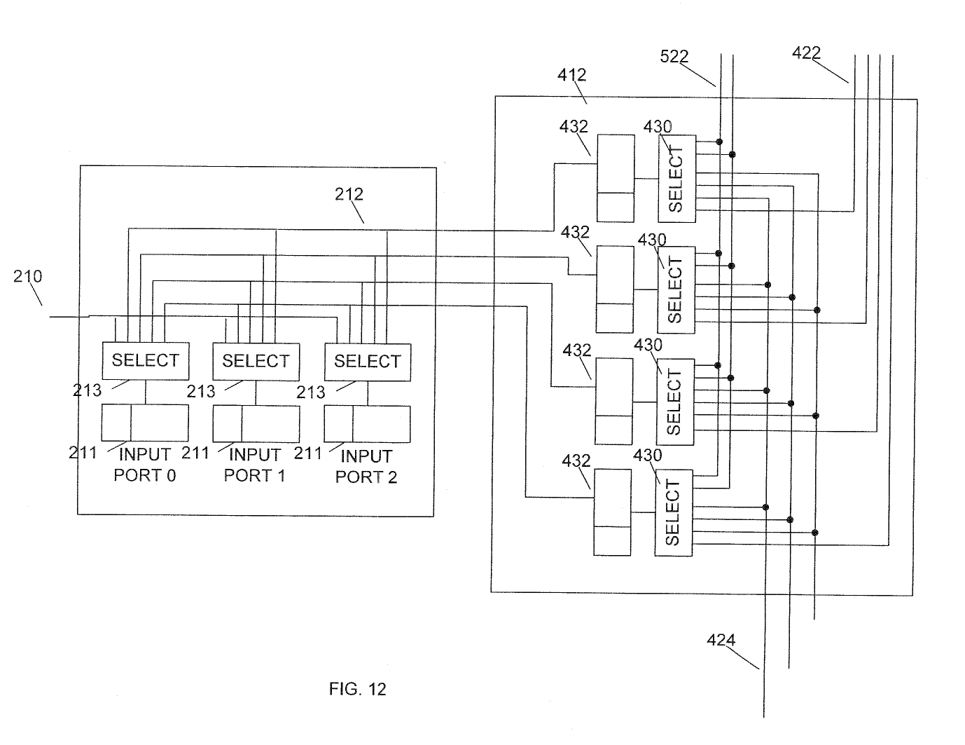

FIG. 12 is a block diagram of a switch portion 412 of an example switch 410 (FIG. 6) connected to a portion 212 of an example processor 230. The processor 230 in FIG. 12 includes three input ports, 0, 1, 2. The switch 412 of FIG. 11 includes four programmable selectors 430, which operate similar to the selectors 420 of FIG. 11. By making appropriate selections, any of the communication lines 422, 424 (FIG. 6), or 418 (described below) that are coupled to the selectors 430 can be coupled to any of the output ports 432 of the switch 412. The output ports 432 of the switch 412 may be coupled through another set of selectors 213 to a set of input ports 211 in the connected processor 230. The selectors 213 can be programmed to set which output port 432 from the switch 412 is connected to the particular input port 211 of the processor 230. Further, as illustrated in FIG. 12, the selectors 213 may also be coupled to a communication line 210, which is internal to the processor 230, for selection into the input port 211.

One example of an example connection between the switches 410 and 510 is illustrated in FIG. 12. In that figure, the communication lines 522 couple directly to the selectors 430 from one of the switches 510. Because of the how switches 410 couple to switches 510, each of the two long distance networks within the circuit 440 illustrated in FIG. 10 is separate. Data can be routed from a switch 510 to a switch 510 on a parallel distance network 525 by routing through one of the intermediate distance network switches 410.

Details of setting up the various switches for either packet switching or circuit switching that can be used to transfer data in any of the above examples is identical or similar to the methods and system described above. Further, although several levels of communication networks have been disclosed, with different effective distances, any number of communication networks and any distance of such networks may be implemented without deviating from the spirit of the invention.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An integrated circuit, comprising:
a plurality of processing elements;
a nearest neighbor communication network between at least some of the processing elements. The nearest neighbor network including storage registers for storing data transfer information; and
a second communication network, separate from the nearest neighbor network, the second communication network including at least two coupled switches also coupled to the nearest neighbor network

2. An integrated circuit according to claim 1, further comprising:
an internal communication network having programmatically selected inputs for sending data to individual execution units within the processing elements.

3. An integrated circuit according to claim 2, wherein an output of an individual execution unit may be coupled to an input of another individual execution unit.

4. An integrated circuit according to claim 2, wherein an output of an individual execution unit may be coupled to an input of the same individual execution unit through a crossbar switch.

5. An integrated circuit according to claim 2. further comprising one or more protocol registers in a data path of the internal communication network.

6. An integrated circuit according to claim 1, further comprising:
a third communication network including at least two coupled switches also coupled to the second communication network.

7. An integrated circuit according to claim 6 in which the switches of the second communication network and the switches of the third communication network both include data storage registers.

8. An integrated circuit, comprising:
a plurality of processor groups arranged in a regular repeating pattern in an available space;
a plurality of first communication paths each contained within a respective one of the plurality of processor groups;
a plurality of nearest neighbor communication paths each coupled between adjacent pairs of the plurality of processor groups; and
a plurality of second communication paths coupled between selected of the adjacent pairs of the plurality of processors, the second communication paths including a first set of switches; wherein data is stored and transfers through registers along at least one of the communication paths.

9. An integrated circuit according to claim 8 in which the first set of switches is dynamically configurable.

10. An integrated circuit according to claim 9 in which the first communication paths comprises a crossbar switch.

11. An integrated circuit according to claim 8, farther comprising:
a plurality of third communication paths coupled between selected of the first set of switches of the plurality of second communication path, and coupled between a second set of switches within the plurality of third communication paths.

12. An integrated circuit of claim 11 in which a first processor in a first of the plurality of processor groups can communicate to a second processor in a second of the plurality of processor groups through the one of the nearest neighbor communication paths, through one of the second communication paths, and through one of the third communication paths.

13. An integrated circuit of claim 8 in which at least one of the communication paths comprises a pair of unidirectional communication paths configured in opposite directions.

14. An integrated circuit of claim 13 in which each of the unidirectional communication paths includes forward protocol data and reverse protocol data.

15. An integrated circuit of claim 8 in which at least two of the first set of switches is connected by more than one separate data path in each direction.

16. A method of transferring data within an integrated circuit, comprising:
configuring an inter-process group communication network to connect an output from a first processor in a first group of processors to an input of a second processor in the first group of processors;
configuring a nearest neighbor communication network to connect an output from the first processor in the first group of processors to an input of a first processor in a second group of processors; and
configuring a second communication network that is separate from the nearest neighbor communication network to connect an output from a second processor in the first group of processors to an input of a second processor in the second group of processors.

17. The method of claim 16 in which configuring an inter-processor group communication network comprises writing data to a register.

18. The method of claim 16 in which configuring a second communication network comprises writing data to one or more programmable switches included within the second communication network.

19. The method of claim 16, further comprising sending data through at least one data register along the nearest neighbor communication network.

20. The method of claim 19, further comprising sending reverse protocol data through the at least one data register.
